(19) United States
(12) Patent Application Publication
(10) Pub. No.: US 2009/0139998 A1
(43) Pub. Date: Jun. 4, 2009

(54) Apparatus for Dispensing Stackable Box Food Containers

(76) Inventor: Rafle P. Guthrie, JR., Gretna, LA (US)

Correspondence Address: RAFLE P. GUTHRIE, JR, 553 DUNKIRK AVENUE, GRETNA, LA, 70056, US

(21) Appl. No.: 11/948,226

(22) Filed: Nov. 30, 2007

(51) Int. Cl. B65G 59/10; B65H 3/26

(52) U.S. Cl. 221/1; 221/22

(57) ABSTRACT

An apparatus for dispensing stackable box food containers the apparatus comprising, in a particular embodiment, an elongated hollow member formed from one or more sidewalls and comprising a first end portion, a second end portion, at least one attachable side and a forward-facing side, the elongated hollow member further forming a front opening on the forward-facing side to facilitate the removal of at least one of the stackable box food containers, and at least one protrusion extending from, and attached to or integral with, an internal surface of the at least one sidewall of the elongated hollow member, the at least one protrusion proximate to the front opening at the second end portion on the forward-facing side, the at least one protrusion extending into space within the hollow member by a distance sufficient to enable the protrusion to aid in retaining the at least one stackable box food container when the at least one stackable box food container is disposed within the elongated hollow member with the at least one stackable box food container opening disposed toward the second end portion.

### TECHNICAL FIELD

This invention relates to an apparatus for dispensing stackable box food containers.

### BACKGROUND

Many restaurants and eateries offer food items conveniently packaged in stackable box food containers such that the stackable box food container contents may be eaten at a location other than the restaurant or eatery. As many stackable box food containers are used in packaging these food items, a storage and dispensing system is needed for the stackable box food containers. Current storage and dispensing systems include among others, plastic wrapping and placement on counters. Such storage and dispensing systems are inefficient and consume much needed counter or tabletop space. A need thus exists for a fast, inexpensive, and convenient storage and dispensing system for the stackable box food containers.

### SUMMARY

The present invention provides a simple, efficient, and inexpensive solution to the need for dispensing stackable box food containers. In one of its aspects, the invention provides an apparatus for dispensing stackable box food containers, each stackable box food container comprising one or more foldable attached lid portions surrounding a stackable box food container opening. The apparatus comprises an elongated hollow member formed from one or more sidewalls and comprising a first end portion, a second end portion, at least one attachable side and a forward-facing side, the elongated hollow member further forming a notch at the second end portion on the forward-facing side to facilitate the removal of at least one of the stackable box food containers, and at least one protrusion extending from, and attached to or integral with, an internal surface of the at least one sidewall of the elongated hollow member, the at least one protrusion proximate to the notch at the second end portion on the forward-facing side, the at least one protrusion extending into space within the hollow member by a distance sufficient to enable the protrusion to aid in retaining the at least one stackable box food container when the at least one stackable box food container is disposed within the elongated hollow member with the at least one stackable box food container opening disposed toward the second end portion.

Another embodiment of the present invention is an apparatus comprising an elongated hollow member formed from one or more sidewalls and comprising a first end portion, a second end portion, at least one attachable side and a forward-facing side, the elongated hollow member further forming a front opening on the forward-facing side to facilitate the removal of at least one of the stackable box food containers, and at least one protrusion extending from, and attached to or integral with, an internal surface of the at least one sidewall of the elongated hollow member, the at least one protrusion proximate to the front opening at the second end portion on the forward-facing side, the at least one protrusion extending into space within the hollow member by a distance sufficient to enable the protrusion to aid in retaining the at least one stackable box food container when the at least one stackable box food container is disposed within the elongated hollow member with the at least one stackable box food container opening disposed toward the second end portion.

Still another embodiment of the present invention is a method for dispensing the aforesaid stackable box food containers. The method comprises

providing an apparatus for dispensing the stackable box food containers, the apparatus comprising an elongated hollow member formed from one or more sidewalls and comprising a first end portion, a second end portion, at least one attachable side and a forward-facing side, the elongated hollow member further forming a notch at the second end portion on the forward-facing side to facilitate the removal of at least one of the stackable box food containers, and at least one protrusion extending from, and attached to or integral with, an internal surface of the at least one sidewall of the elongated hollow member, the at least one protrusion proximate to the notch at the second end portion on the forward-facing side, the at least one protrusion extending into space within the hollow member by a distance sufficient to enable the protrusion to aid in retaining the at least one stackable box food container when the at least one stackable box food container is disposed within the elongated hollow member with the at least one stackable box food container opening disposed toward the second end portion;

loading at least one of the stackable box food containers into the second end portion of the elongated hollow member whereby the at least one stackable box food container is disposed within the elongated hollow member with the at least one container opening disposed toward the second end portion and at least one of the one or more foldable attached lid portions contacting the at least one protrusion;

manipulating a first side portion of the one or more foldable attached lid portions toward an opposing second side portion of the one or more foldable attached lid portions until the first side portion of the attached lid portion is no longer disposed between the at least one protrusion and the forward-facing side; and

withdrawing at least one stackable box food container from the elongated hollow member.

Yet another embodiment of the present invention is a method for dispensing the stackable box food containers, the method comprising

providing an apparatus for dispensing stackable box food containers, each stackable box food container comprising one or more foldable attached lid portions surrounding a stackable box food container opening, the apparatus comprising an elongated hollow member formed from one or more sidewalls and comprising a first end portion, a second end portion, at least one attachable side and a forward-facing side, the elongated hollow member further forming a front opening on the forward-facing side to facilitate the removal of at least one of the stackable box food containers, and at least one protrusion extending from, and attached to or integral with, an internal surface of the at least one sidewall of the elongated hollow member, the at least one protrusion proximate to the front opening at the second end portion on the forward-facing side, the at least one protrusion extending into space within the hollow member by a distance sufficient to enable the protrusion to aid in retaining the at least one stackable box food container when the at least one stackable box food container is disposed within the elongated hollow member with the at least one stackable box food container opening disposed toward the second end portion;

loading at least one of the stackable box food containers into the second end portion of the elongated hollow member whereby the at least one stackable box food container is disposed within the elongated hollow member with the at least one container opening disposed toward the second end portion and at least one of the one or more foldable attached lid portions contacting the at least one protrusion;

manipulating a first side portion of the one or more foldable attached lid portions toward an opposing second side portion of the one or more foldable attached lid portions until the first side portion of the attached lid portion no longer contacts the at least one protrusion; and

withdrawing at least one stackable box food container from the elongated hollow member.

These and other implementations and features of the invention will be still further apparent from the ensuing description, accompanying drawings and appended claims.

### BRIEF DESCRIPTION OF THE DRAWINGS

FIG. 1 is a perspective view of the rectangular container consistent with one embodiment of the present invention.

FIG. 2 is a perspective view of the second end portion in accordance with the embodiment of FIG. 1.

FIG. 3 is a bottom plan view of the second end opening in accordance with the embodiment of FIG. 1.

FIG. 4 is a perspective view of the rectangular container consistent with an alternate embodiment of the present invention.

Like reference numbers or letters are used in the figures to reference like parts or components amongst the several figures.

### DETAILED DESCRIPTION OF THE INVENTION

The present invention enables busy cooks and servers to easily and efficiently access, dispense and store large numbers of box food containers of the sort herein described. It does so by employing a device and/or methodology which is elegantly simple.

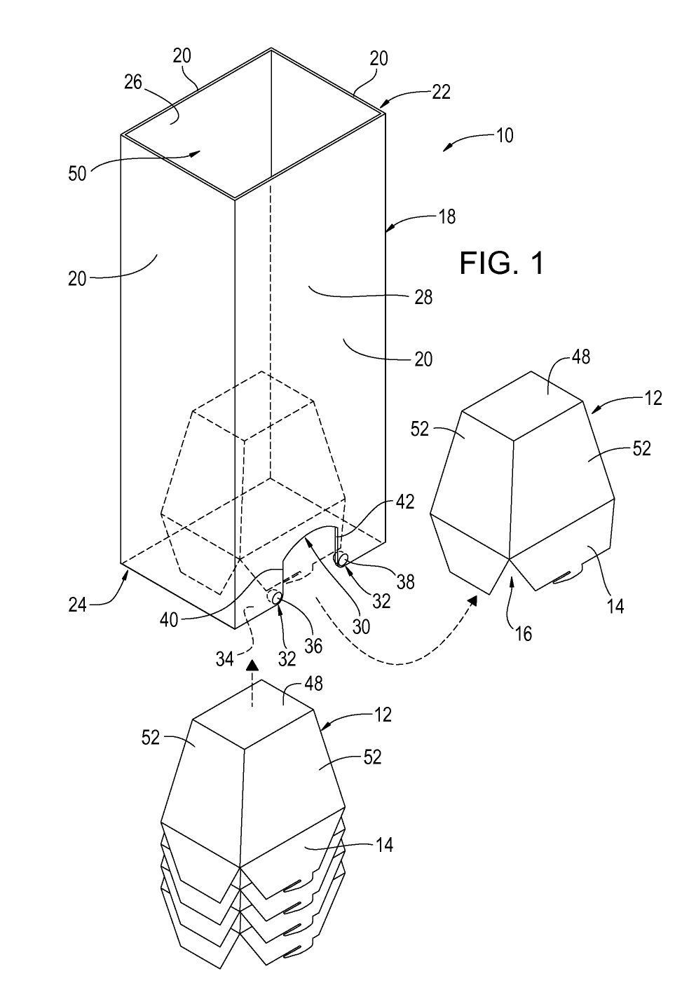

Referring now descriptively to the drawings, the attached figures illustrate an apparatus 10 for dispensing stackable box food containers 12 according to one particular exemplification of the present invention. Turning now to FIG. 1, a particular embodiment of the present invention comprises an elongated hollow member illustrated as a rectangular container 18 comprising a first end portion 22 and a second end portion 24, an attachable side 26, and a forward-facing side 28. The rectangular container 18 further forms a notch 30 at second end portion 24 on forward-facing side 28 to facilitate the removal of at least one stackable box food container 12.

Each stackable box food container 12 shown in FIG. 1 comprises foldable attached lid portions 14 surrounding a stackable box food container opening 16. Stackable box food container 12 comprises four sidewalls 52 and a bottom surface 48. Each sidewall 52 is attached to a respective foldable lid portion 14. It should be appreciated that the number of sidewalls and foldable lid portions of stackable box food containers used in a particular embodiment of the invention may vary without deviating from the scope and spirit of the invention. Similarly, it should be appreciated that other containers used for purposes besides food may be used in a particular embodiment.

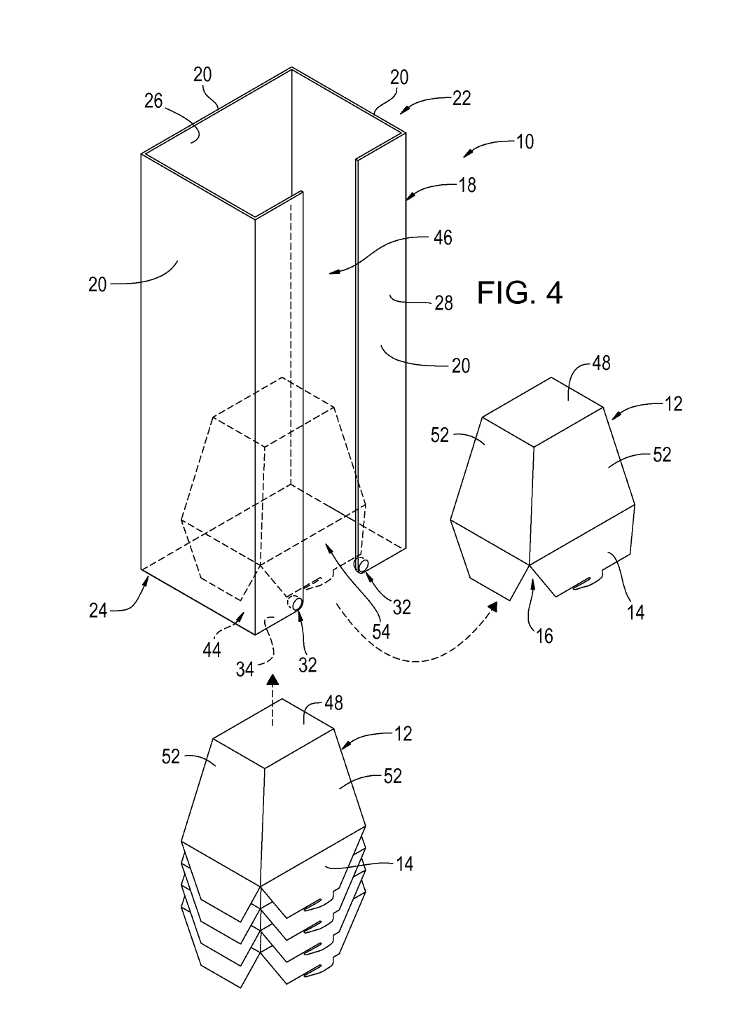

Although the elongated hollow member is illustrated in FIG. 1 and FIG. 4 as rectangular container 18 comprising four sidewalls 20, it should be appreciated that the elongated hollow member may form different configurations (e.g., square or cylinder) as long as at least one sidewall forms at least a semi-enclosed space capable of retaining the food containers. As shown in FIG. 1, attachable side 26 opposes forward-facing side 28. Attachable side 26 further comprises an attachment means (not shown) for attaching rectangular container 18 to a support structure (not shown) while enabling a user (not shown) to access the stackable box food containers 12 through notch 30 to dispense stackable box food containers 12 from second end portion 24 of rectangular container 18 when rectangular container 18 is so attached to support structure (not shown). The attachment means may include screwing, bolting, welding, gluing, or the like. It should be appreciated that the attachable side may be a sidewall adjacent to forward-facing side or the rectangular container may have more than one attachable side which may be dependent on the surface structure to which the rectangular container may be attached.

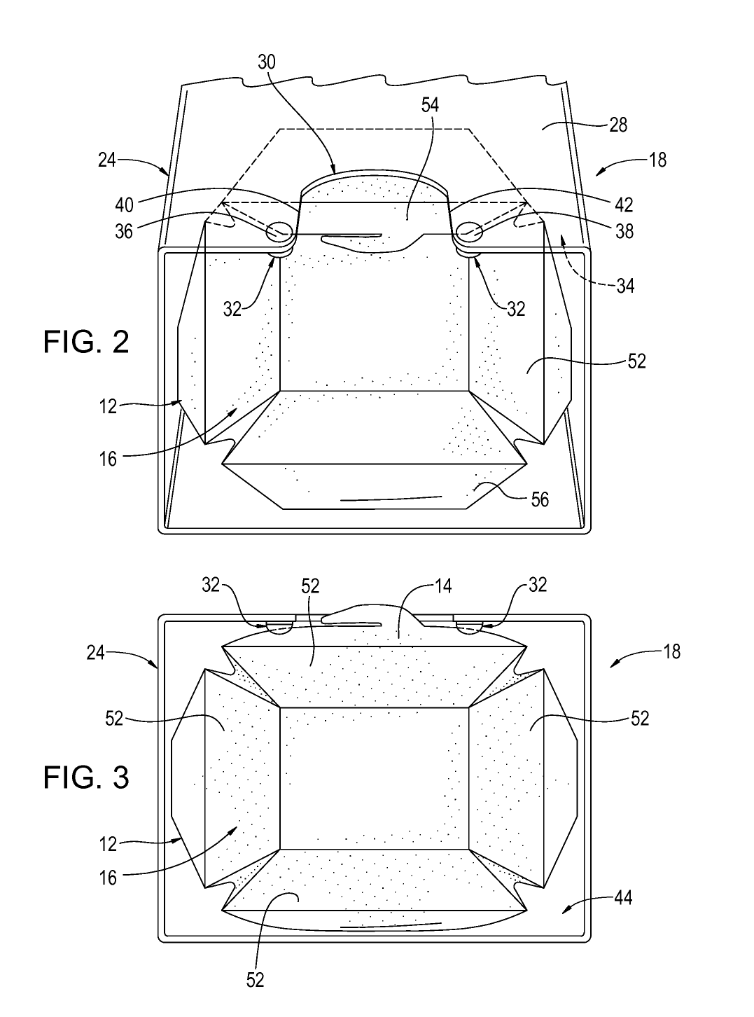

As shown in FIG. 1 and illustrated further in FIG. 2 and FIG. 3, two protrusions 32 extend from and are attached to an internal surface 34 of rectangular container 18. Each protrusion 32 is proximate to notch 30 at second end portion 24 on forward-facing side 28 and extends into space within rectangular container 18 by a distance sufficient to enable protrusion 32 to aid in retaining at least one stackable box food container 12 when at least one stackable box food container 12 is disposed within rectangular container 18 with stackable box food container opening 16 disposed toward second end portion 24. In FIG. 2, first protrusion 36 is proximate to a first side portion 40 of notch 30 and a second protrusion 38 is proximate to an opposing second side portion 42 of notch 30. The number of protrusions and the location of the protrusions proximate to the notch may vary. The protrusion may be attached to the sidewall by bolting, screwing, gluing, braising, welding, or the like, or the protrusion may be integral with the internal surface of the sidewall of the rectangular container.

With respect to FIG. 3, the embodiment as illustrated in FIG. 1 and FIG. 2 is shown from a different perspective. Previously described features will only be repeated as necessary. Second end portion 24 of rectangular container 18 further forms a second end portion opening 44. Second end portion opening 44 is sized and configured to receive at least one stackable box food container 12 so that stackable box food container 12 is disposed within rectangular container 18 with stackable box food container opening 16 disposed toward second end portion 24.

Referring now to FIGS. 1-3, stackable box food containers 12 are loaded into second end opening 44 of second end portion 24 of rectangular container 18 whereby at least one stackable box food container 12 is disposed within rectangular container 18 with at least one stackable box food container opening 16 disposed toward second end portion 24 and at least one of the one or more foldable attached lid portions 14 contacting at least one protrusion 32. As shown, a plurality of box food containers 12 may be loaded into second end portion opening 44 of second end portion 24 of rectangular container 18 at one time. Once stackable box food container opening 16 of stackable box food container 12 is disposed toward second end portion 24 and one foldable attached lid portion 14 contacts protrusion 32, stackable box food container 12 may be removed from second end opening 44 by a user (not shown) manipulating a first side portion 54 of an attached lid portion 14 toward an opposing second side portion 56 of an attached lid portion 14 until the first side portion 54 of attached lid portion 14 is no longer disposed between protrusion 32 and forward-facing side 28 and stackable box food container 12 may be withdrawn from rectangular container 18.

A shown in FIG. 1, rectangular opening 18 comprises first end portion 22 which further comprises a first end portion opening 50. It should be appreciated that the stackable box food containers may also be removed from the first end portion opening or loaded from the first end portion opening without deviating from the scope and spirit of the invention. Further, the rectangular container may comprise a first end portion comprising an attachable or detachably attachable cover.

FIG. 4 illustrates an alternate embodiment of the present invention wherein an elongated hollow member is illustrated as a rectangular container 18 comprising a first end portion 22, a second end portion 24, an attachable side 26, and a forward-facing side 28. Rectangular container 18 further forms a front opening 46 on forward-facing side 28 to facilitate the removal of at least one of the stackable box food containers 12. The width of front opening 46 may vary and is dependent on the desired placement of the protrusions 32 and their ability to retain the stackable box food containers 12. Second end portion 24 of rectangular container 18 further forms a second end portion opening 44. Second end portion opening 44 is sized and configured to receive at least one stackable box food container 12 so that stackable box food container 12 is disposed within rectangular container 18 with stackable box food container opening 16 disposed toward second end portion 24. It should be appreciated that front opening may extend from the second end portion to the first end portion or may terminate at any distance from the second end portion without deviating from the scope and spirit of the present invention.

As shown in FIG. 4, two protrusions 32 extend from and are attached to an internal surface 34 of at least one sidewall 20 of rectangular container 18. Each protrusion 32 is proximate to front opening 46 at second end portion 24 on forward-facing side 28 and extends into space within the rectangular container 18 by a distance sufficient to enable protrusion 32 to aid in retaining stackable box food container 12 when stackable box food container 12 is disposed within the rectangular container 18 with the stackable box food container opening 16 disposed toward second end portion 24. The protrusion may be attached to the sidewall by bolting, screwing, gluing, braising, welding, or the like, or the protrusion may be integral with the internal surface of the sidewall of the rectangular container.

Still referring to the particular embodiment of FIG. 4, stackable box food containers 12 are loaded into second end opening 44 of second end portion 24 of rectangular container 18 whereby at least one stackable box food container 12 is disposed within rectangular container 18 with at least one stackable box food container opening 16 disposed toward second end portion 24 and at least one of the one or more foldable attached lid portions 14 contacting at least one protrusion 32. As shown, a plurality of stackable box food containers 12 may be loaded into second end portion opening 44 of second end portion 24 of rectangular container 18 at one time. Once a stackable box food container opening 16 of a stackable box food container 12 is disposed toward second end portion 24 and one foldable attached lid portion 14 contacts protrusion 32, stackable box food container 12 may be removed from second end opening 44 by a user (not shown) manipulating the first side portion 54 of an attached lid portion 14 toward the opposing second side portion (not shown) of an attached lid portion 14 until first side portion 54 of attached lid portion 14 is no longer disposed between protrusion 32 and forward-facing side 28 and stackable box food container 12 may be withdrawn from rectangular container 18.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

That which is claimed is:

1. An apparatus for dispensing stackable box food containers, each stackable box food container comprising one or more foldable attached lid portions surrounding a stackable box food container opening, the apparatus comprising
an elongated hollow member formed from one or more sidewalls and comprising a first end portion, a second end portion, at least one attachable side and a forward-facing side, the elongated hollow member further forming a notch at the second end portion on the forward-facing side to facilitate the removal of at least one of the stackable box food containers, and
at least one protrusion extending from, and attached to or integral with, an internal surface of the at least one sidewall of the elongated hollow member, the at least one protrusion proximate to the notch at the second end portion on the forward-facing side, the at least one protrusion extending into space within the hollow member by a distance sufficient to enable the protrusion to aid in retaining the at least one stackable box food container when the at least one stackable box food container is disposed within the elongated hollow member with the at least one stackable box food container opening disposed toward the second end portion.

2. The apparatus of claim 1 wherein each protrusion is proximate to the notch at the second end portion on the forward-facing side of the elongated hollow member.

3. The apparatus according to claim 2 wherein the at least one protrusion comprises a first protrusion proximate to a first side portion of the notch and a second protrusion proximate to an opposing second side portion of the notch.

4. The apparatus of claim 3 wherein the at least one sidewall further comprises a first sidewall, a second sidewall, a third sidewall, and a fourth sidewall.

5. The apparatus of claim 4 wherein the notch is formed from any one of the sidewalls of the elongated hollow member.

6. The apparatus of claim 5 wherein the at least one attachable side further comprises attachment means for attaching the hollow member to a support structure while enabling a user to access the stackable box food containers through the notch to dispense the containers from the second end portion of the elongated hollow member when the elongated hollow member is so attached to the support structure.

7. The apparatus of claim 6 wherein the second end portion of the elongated hollow member further forms a second end portion opening, the second end portion opening being sized and configured to receive at least one stackable box food container so that the at least one stackable box food container is disposed within the elongated hollow member with the at least one stackable box food container opening disposed toward the second end portion.

8. An apparatus for dispensing stackable box food containers, each stackable box food container comprising one or more foldable attached lid portions surrounding a stackable box food container opening, the apparatus comprising
an elongated hollow member formed from one or more sidewalls and comprising a first end portion, a second end portion, at least one attachable side and a forward-facing side, the elongated hollow member further forming a front opening on the forward-facing side to facilitate the removal of at least one of the stackable box food containers, and
at least one protrusion extending from, and attached to or integral with, an internal surface of the at least one sidewall of the elongated hollow member, the at least one protrusion proximate to the front opening at the second end portion on the forward-facing side, the at least one protrusion extending into space within the hollow member by a distance sufficient to enable the protrusion to aid in retaining the at least one stackable box food container when the at least one stackable box food container is disposed within the elongated hollow member with the at least one stackable box food container opening disposed toward the second end portion.

9. The apparatus of claim 8 wherein the front opening on the forward-facing side is a notch formed from the elongated hollow member at the second end portion.

10. The apparatus of claim 9 wherein each protrusion is proximate to the notch at the second end portion on the forward-facing side of the elongated hollow member.

11. The apparatus of claim 10 wherein the at least one protrusion comprises a first protrusion proximate to a first side portion of the notch and a second protrusion proximate to an opposing second side portion of the notch.

12. The apparatus of claim 11 wherein the at least one sidewall further comprises a first sidewall, a second sidewall, a third sidewall, and a fourth sidewall.

13. The apparatus of claim 12 wherein the notch is formed from any one of the sidewalls of the elongated hollow member.

14. The apparatus of claim 13 wherein the at least one attachable side further comprises attachment means for attaching the hollow member to a support structure while enabling a user to access the stackable box food containers through the front opening to dispense the containers from the second end portion of the elongated hollow member when the elongated hollow member is so attached to the support structure.

15. The apparatus of claim 14 wherein the second end portion of the elongated hollow member further forms a second end portion opening, the second end portion opening being sized and configured to receive at least one stackable box food container when the at least one stackable box food container is disposed within the elongated hollow member with the at least one stackable box food container opening disposed toward the second end portion.

16. A method for dispensing stackable box food containers comprising foldable attachable lid portions, each stackable box food container comprising one or more foldable attached lid portions surrounding a stackable box food container opening, the method comprising
providing the apparatus of claim 1;
loading at least one of the stackable box food containers into the second end portion of the elongated hollow member whereby the at least one stackable box food container is disposed within the elongated hollow member with the at least one container opening disposed toward the second end portion and at least one of the one or more foldable attached lid portions contacting the at least one protrusion;
manipulating a first side portion of the one or more foldable attached lid portions toward an opposing second side portion of the one or more foldable attached lid portions until the first side portion of the attached lid portion is no longer disposed between the at least one protrusion and the forward-facing side; and
withdrawing at least one stackable box food container from the elongated hollow member.

17. The method of claim 16 further comprising attaching at least one sidewall of the elongated hollow member to a support structure without obstructing user access to the second end portion of the elongated hollow member.

18. The method of claim 17 further comprising loading a plurality of box food containers into the second end portion of the elongated hollow member.

19. A method for dispensing stackable box food containers comprising foldable attachable lid portions, each stackable box food container comprising one or more foldable attached lid portions surrounding a stackable box food container opening, the method comprising
providing the apparatus of claim 8;
loading at least one of the stackable box food containers into the second end portion of the elongated hollow member whereby the at least one stackable box food container is disposed within the elongated hollow member with the at least one container opening disposed toward the second end portion and at least one of the one or more foldable attached lid portions contacting the at least one protrusion;
manipulating a first side portion of the one or more foldable attached lid portions toward an opposing second side portion of the one or more foldable attached lid portions until the first side portion of the attached lid portion no longer contacts the at least one protrusion; and
withdrawing at least one stackable box food container from the elongated hollow member.

20. The method of claim 19 further comprising attaching at least one sidewall of the elongated hollow member to a support structure without obstructing user access to the second end portion of the elongated hollow member.

21. The method of claim 20 further comprising loading a plurality of box food containers into the second end portion of the elongated hollow member.
